(19) United States
(12) Patent Application Publication
(10) Pub. No.: US 2014/0279604 A1
(43) Pub. Date: Sep. 18, 2014

(54) Compliance Service Center

(71) Applicant: Steve A. Chavez, Albuqueque, NM (US)

(72) Inventor: Steve A. Chavez, Albuqueque, NM (US)

(21) Appl. No.: 13/844,335

(22) Filed: Mar. 15, 2013

(51) Int. Cl. G06Q 30/00

(52) U.S. Cl. CPC G06Q 30/018
USPC 705/317

(57) ABSTRACT

Disclosed is a Compliance Service Center comprising of technology: Servers, plurality of bidirectional Data Collection Devices, Internet Services, Web Sites. Software platforms comprising: Service Rules/Policies, Service Schedules, Service Assignments, Data Collection Services and devices, Compliance Board (Oversight), Delivered Services (Insight), Pay Board, Archive Center, Automation Board and Third Party Interfaces. Compliance Monitoring is performed 24 hours a day 7 days a week on all scheduled services with Service Infractions reported on a plurality of bidirectional Data Collection Devices.

Compliance Monitoring is essential in servicing consumer on timely basis for their scheduled service periods. It improves customer service, quality of service and fulfills contractual service obligations.

### 1. FIELD OF INVENTION

Present invention relates to systems and methods for performing Compliance Services on contractual and Non-contractual services.

### 2. Description of Prior Art

| | | |
|---|---|---|
| US Patent Number 2008/0125959 | May 2008 | Doherty et al. |

### METHOD, SYSTEM AND COMPUTER PROGRAM FOR DETECTING AND MONITORING HUMAN ACTIVITY UTILIZING LOCATION DATA

Problem with this solution it does not address Compliance Service issues and leaves the company open for audits.

| | | |
|---|---|---|
| US Patent Number 2009/0030731 | January 2009 | Reiner |

Method and apparatus for generating a patient quality assurance

Problem with this solution it does not address Compliance Service issues.

| | | |
|---|---|---|
| US Patent Number 2008/0058615 | March 2008 | Clapp et al. |

### HOME CARE LOGISTICS AND QUALITY ASSURANCE SYSTEM

Problem with this solution it does not address Compliance Service issues.

U.S. Pat. No. 20060111955 May 25, 2006 Winter et al.

System and method for mobile resource management with customer confirmation Problem with this solution it does not address Compliance Service Rules and Policies issues and leaves the company open for audits and fines.

### 3. SUMMARY OF THE INVENTION

The Service Industry be it Health Care Services, Custodial Care or Commercial Services has lacked the structure, organization, methods and services to monitor service providers on how effective they are performing their assigned services. Normal response has been it is difficult because most of the work is performed manually and it would be to costly and labor intensive.

Software applications they have installed are primary accounting applications. Companies try to use their Time and Attendance or Payroll applications and cannot accomplish the task of Compliance Monitoring. Because they are employee based and only have employee schedules which fall short of the type of work required. Most of these applications are based on batch processing rather than real time when services are being provided. They have no Company and State Compliance Rules and Policies or the contractual and non-contractual service plans, staffing requirements and certification requirements for service providers to insure they are legal to work an account or with a consumer. This industry has a large turn over on Staff and trying to maintain Staffing schedules requires a lot of time and money.

### 4. BRIEF DESCRIPTION OF THE DRAWINGS

FIG. 1 Pictorial overview on the Compliance Service Center work flow.

FIG. 2 Compliance Board screen shot.

### 5. DETAILED DESCRIPTION OF THE INVENTION

Compliance Service Center is a system of software application platforms which perform Compliance Monitoring and reporting at the time service activity is received from the service provider using data logging devices or equipment.

The Compliance Service Center is a system of defined procedures and methods which brings Structure, Organization, Accountability, Discipline, Oversight and Insight to an organization. Compliance Services are essential to a Service Organization which is accountable for its performance to its consumers first and then to the State and Federal agencies second them to its Board of Trustees.

Compliance monitoring during a shift enables the Compliance Officer the opportunity to see exactly what is taking place in the field and service locations Infractions, arising issues are addressed at the time they occur instead of one or two week out where nothing can be resolved because it is to late to take corrective action. Taking Action on service infractions during a shift lets staff members know what they are doing and are not doing. This over a short time resolves many recurring issues which can lead to larger problems or lawsuits. Overtime will begin to drop because you have tools to stop time fabrication before it gets out of hand. You will see improvements in customer service and contract fulfillment. Simply because your Compliance Officer is on top of issues during the shift and they have the ability to contact the service provider to resolve the issue at hand.

Compliance Service Center is easy to setup due to the current information on your employees within your Payroll System. Service schedule can imported from spreadsheets. Rule and Policies are posted to the Service Center.

We claim:

1. A Compliance Service Center comprised of computer technology hardware, software and services. Such as servers, Web Sites, Cloud Services, Internet Services, Networking Service and plurality of bidirectional Communication Services/Networks and a plurality of bidirectional data collection equipment, plurality of devices and Web Sites. Open architecture for equipment and device interfaces and connectivity. Compliance Service Center centralizes Daily Service Activity (24/7/365) in near real time using information supplied by modules and software platforms comprising: Service Rules/Policies, Service Schedules, Service Assignments, Data Collection Services and devices, Compliance Board (Oversight), Delivered Services (Insight), Pay Board, Archive Center, Automation Board and Third Party Interfaces. Compliance Service Center applies the Company and State Rules, Policies, and Service Schedules in near real time on Delivered Services on the Compliance Board dashboard reflecting Compliance Performance (color coded) by account. Color coding reflects accounts with compliance issues which need to be resolved ASAP. Compliance Officers can navigate through multiple Division and Branch locations viewing 150 accounts per dashboard (Larger Dashboard are available for viewing) or they can view or print one dashboard with all accounts having compliance issues. Corrective Actions taken by Compliance Officers are posted to Service Tickets (Compliance Documentation) for the account and are forwarded to the department manager and HR for further action if required. Service Tickets which have not been followed up on will be forwarded to the Compliance Director for immediate attention. Compliance Service Center has tools to assist the Compliance Officer in locating staff to fill in as replacement personnel on situations were a scheduled staff member has become ill or is not able to work the assigned shift. State's have specific requirements on personnel who will be servicing the account or consumer. These requirements are encoded into the Compliance Service Center and will select staff members who meet the criteria to be used as a staff member replacement at the account or with a consumer. Compliance Officer will be notified if the replacement Staff member will go into overtime if they work the shift and if will place them into consecutive time worked status.

2. Compliance Service Center of claim 1, wherein equipment and device interfaces and connectivity allows a plurality of equipment and devices to be connected to the Compliance Service Center allowing organization to use pre-existing equipment and devices if they can be interfaced.

3. Compliance Service Center of claim 1, wherein near real time using information supplied by modules and software platforms which take time to collect data and process.

4. Compliance Service Center of claim 1, wherein Company and State Rules and Policies are encoded into the Rules and Policies database.

5. Compliance Service Center of claim 3, wherein are used to confirm current Service Activity being performed in the field or at service locations are in compliance with Company and State Rules and Policies.

6. Compliance Service Center of claim 1, wherein Service Schedules are posted from the Master Service Plan for each account.

7. Compliance Service Center of claim 1, wherein Compliance dashboard reflecting Compliance Performance if accounts have a service infraction it will be color coded based on the infraction.

8. Compliance Service Center of claim 1, wherein Compliance officers and Administrators can visually see 150 accounts at a time with color coding were service infractions have been located.

9. Compliance Service Center of claim 1, wherein on demand reports can be produced on any dashboard.

10. Compliance Service Center of claim 1, wherein Service Tickets (Compliance Documentation) is a service audit trial on Action Taken to resolve an issue.

11. Compliance Service Center of claim 1, wherein consecutive time worked infraction is based on the total number of consecutive hours worked i.e. after 16 hours the service provider must have 8 hours off.
